(19) United States
(12) Patent Application Publication
(10) Pub. No.: US 2010/0280151 A1
(43) Pub. Date: Nov. 4, 2010

(54) TOUGHENED FIBER REINFORCED POLYMER COMPOSITE WITH CORE-SHELL PARTICLES

(75) Inventors: Felix N. NGUYEN, Tacoma, WA (US); Norimitsu NATSUME, Tacoma, WA (US)

Correspondence Address: PILLSBURY WINTHROP SHAW PITTMAN, LLP, P.O. BOX 10500, MCLEAN, VA, 22102, US

(73) Assignee: TORAY INDUSTRIES, INC., Tokyo (JP)

(21) Appl. No.: 12/771,220

(22) Filed: Apr. 30, 2010

Related U.S. Application Data
(60) Provisional application No. 61/175,345, filed on May 4, 2009.

(51) Int. Cl. C08K 3/04; C08L 63/00

(52) U.S. Cl. 523/215; 525/524

(57) ABSTRACT

Embodiments disclosed herein include a resin composition comprising two or more different kinds of thermosetting resins, wherein at least one of the two or more different kinds of the thermosetting resins is a multifunctional resin, and a core-shell particle having a core and a shell, wherein a composition of the core is different from a composition of the shell and the composition of the shell has a branched polymer structure comprising at least one main chain and at least one side chain, the main chain or the side chain containing at least one functional group that reacts with the thermosetting resin, a method of manufacturing the resin composition, and a composite comprising a reinforcing fiber and the resin composition.

### RELATED APPLICATION

This application claims benefit under 35 U.S.C. §119(e) to U.S. Provisional Patent Application No. 61/175,345, filed May 4, 2009. The contents of that application are incorporated herein in their entirety by reference.

### FIELD OF THE INVENTION

The present invention relates to a resin composition containing a thermosetting resin and core-shell particles and to a fiber reinforced polymer composite containing the resin composition such that the composite simultaneously has a high fracture toughness and compressive properties.

### BACKGROUND OF THE INVENTION

When two or more bulk components are combined to achieve desired properties of a structure, the final material constitutes a composite system such as fiber-reinforced polymer (FRP) composites. Such composite systems give the structure not only excellent mechanical properties, but also light weight and often cost savings in both fabrication and operation compared to those made from metals. For this reason, many metal parts and complex structures have been replaced by those prepared from advanced FRP composite materials. FRP composites have been found in many applications in the industries of space and aerospace, automobile, sporting goods, civil, medicine, electronics, arms, and more.

Structural polymers are divided into thermosets or cross-linkable polymers that are cross-linked by curing, and thermoplastics or uncrosslinkable polymers. Some of main advantages for which thermosetting polymers are more preferred over thermoplastic polymers for FRP composite material designs include ease of processing due to much lower viscosity before curing, and typically excellent mechanical, chemical and thermal characteristics after cured. Yet, thermosetting polymers are more brittle after cured, and hence suffer from low fracture toughness or resistance to crack growth. Consequently, when an untoughened thermosetting polymer is used to make a FRP system, the composite subsequently could have a low damage resistance and tolerance.

It has been shown that, however, the overall damage resistance and tolerance of a FRP composite part do not simply depend on the properties of individual material components but on the integration of these components in the composite. In other words, toughening the polymer is necessary, but fracture toughness enhancement achieved in the polymer is not necessarily translated to increased fracture resistance and tolerance of the composite. The construction or design of the composite material to where the toughening material is located spatially in the cured structure, leading to its interactions with the fibers and the resin matrix, is essentially the key.

Two approaches have been identified to enhance the fracture resistance of FRP composites in response to different types of loading. Interlayer toughening as described in U.S. Pat. No. 5,413,847 (Kishi et al., Toray Industries, Inc., Japan) or U.S. Pat. No. 5,605,745 (Recker et al., Cytec Technology Corp., U.S.) refers to a technique that concentrates a thermoplastic additive (e.g., polyimide, polyamide) embedded in a resin outside the reinforcing fiber bundles in the cured composites. In other words, the additive is confined in the interlayer area or the resin zone between two bundles of fibers. This requires that the domain size of the thermoplastic additive in the resin be greater than the fiber diameter or the spacing between two fibers. Typically, it is from 2 to 50 micron. While the thermoplastic additive moderately resists crack growth in the resin, i.e., moderately enhances fracture toughness measured by a critical stress intensity factor (K_{IC}), it significantly absorbs impact energy, while resisting and confining crack growth within the interlayer areas. This leads to significant enhancements in compression after impact (CAI) and Mode II interlaminar fracture toughness (G_{IIC}) of the FRP composite. The former is a measure of the damage tolerance. The latter is a measure of how well the composite part resists impact loads. In this case, cracks generated due to quasi-static bending of the part experience in-plane shear load, which tends to slide one crack face with respect to the other.

The other toughening approach called interlayer toughening refers to the technique of populating a tough additive throughout the composite material, i.e., in the interlayer area and inside the fiber bed. This additive retains its spatial distribution upon curing. Particle size in this case is supposed to be less than 1 micron. This technique has been shown to enhance Mode I interlaminar fracture toughness of the FRP composite (G_{IC}), which is a measure of how well the material resist crack opening due to tension or compression load.

Many attempts have been made to improve G_{IC} by enhancing toughness of the thermosetting resin system. This can be done by embedding the resin with a toughening agent. Current effective toughening approaches rely on using polymeric toughening agents such as block copolymer and preformed core-shell rubber (CSR) particles. Block copolymers such as Nanostrength® by Arkema are typically synthesized from unsaturated carbon-carbon monomers such as methyl methacrylate, butadiene, styrene, propylene, ethylene oxide. Depend on the solvent, synthesis and post-processing conditions, the resulting copolymer structure might be linear (i.e., worm-like), branched, or spherical by the assembly of individual copolymer molecules or group of self-assembled molecules. CSR particles, on the other hand, is an embodiment of self-assembled block copolymer having a soft rubbery polymer (e.g., polybutadiene or PB) as core and a harder polymer (e.g., polymethylmethacrylate or PMMA) as shell. For both cases, the toughening effect relies on the rubbery component to induce matrix deformations, such as shear band formation and cavitation, through which crack energy is dissipated. Court el al. (Atofina, France) and Oosedo et al. (Toray Industries, Japan) have employed such materials in their formulations as described in U.S. Pat. No. 6,894,113 and U.S. Pat. No. 6,063,839, respectively. Nanoresin® extended the concept by introducing reactive functional groups on the shell and commercialized the product line of Albidur. Similar reactive core-shell particles were presented in U.S. Pat. No. 6,878,776 (Pascault et al., Cray Valley, France). Another type was proposed in U.S. Pat. No. 6,093,777 (Sorensen et al., Perstorp AB, Sweden) in which the shell was a hyperbranched/dendritic polymer and the core, however, was un-reactively hollow. For all of these cases, since a very soft material was incorporated in the resin in a large amount either by weight or volume, the modulus was substantially reduced. This, in turn, leads to a substantial reduction in the compressive properties of the FRP composite.

Hard particles from inorganic materials such as glass nanoparticles from Nanopox® F400 by Hanse Chemie can be used to avoid modulus penalty. However, the toughness enhancement is marginal with such hard particles. Combination of polymeric and inorganic tougheners, on the other hand, are expected to improve fracture toughness while retain the modulus. However, this combination might complicate the fabrication of the FRP composites.

U.S. Pat. No. 5,266,610 (Malhotra et al., ICI Composites Inc.) employed a new type of core-shell particles with silica core combined with an elastomeric shell, which is commercially available from Zeon Chemicals such as DuoMod DP 5078 (formerly known as Nipol 5078). However, the overall particle size was 6-70 um as described by EP 0486044 (Chan et al., Hercules Incorporated), which might not be suitable for the intralayer toughening approach.

Recently, Nguyen's dissertation (2007, University of Washington, Seattle, Wash.) has shown that when using an amino dendrimer, viz., polyethyleneimine (PEi), grafted to a hard polymer such as polystyrene (PS) to toughen an epoxy resin, fracture toughness, measured by critical stress intensity factor K_{IC}, increased substantially without decreasing the modulus. The copolymer was shown to self-assemble into a spherical core-shell structure having a hard core and a soft shell, with the core of PS and the shell of PEi. New toughening mechanisms were discovered including dramatic interphase stretching followed by core stretching and breaking It was rationalized that PEi behaved as a soft reactive shell that provided fracture toughness enhancement, while PS formed a hard core that retained the composite's modulus, which would possibly have been lost if PEi was used alone.

Such amine functionalized core-shell particles were originated by an approach invented in U.S. Pat. No. 2,529,315 (Standard Oil Development Company, 1950). A water-soluble amine was used as a polymerization promoter to accelerate a conventional polymerization reaction of unsaturated carbon-carbon monomers in water containing an emulsifier and a catalyst or an initiator. An aliphatic mercaptan compound could be used to further enhance reaction acceleration at a temperature up to 60° C. One part of monomer or monomer mixture was mixed with up to two parts of water. The emulsifier was alkali metal salts (e.g., sodium dodecyl sulfate) or ammonium salts of high molecular weight fatty acids (e.g., oleate acid), while the catalyst was selected from a group of peroxides such as hydrogen peroxide, t-butyl hydroperoxide, perborates, persulfates, and organo metallic compounds (e.g., iron carbonyl). The amine, on the other hand, was a water-soluble primary, secondary or tertiary amine, which could be aliphatic, alicyclic, or heterocyclic. The amount of emulsifier, catalyst, and promoter were used up to 5 wt %, 0.6 wt %, and 0.5 wt % of the monomers used, respectively. Following the same concept, U.S. Pat. No. 6,359,032 (Kao Corporation, 2002) and U.S. Pat. No. 6,573,313 (The Hong Kong Polytechnic University, 2003) used a macromolecule containing amino groups such as chitosan to accelerate their polymerization reaction of unsaturated carbon-carbon monomers in water containing an emulsifier and initiator to obtain core-shell particles. In both cases, the amino compound was found to be present in the shell of these particles. U.S. Pat. No. 6,573,313 further claimed that if such an amino macromolecule was present, it acted like an emulsifier; therefore, no additional emulsifier would have been needed. Following U.S. Pat. No. 6,573,313, Nguyen's dissertation further explored the use of a polar solvent other than water, viz. isopropyl alcohol, to made similar particles. It was confirmed that the amino compound was also incorporated in the shell. In addition, it was demonstrated that such particles without undergoing a purifying process when incorporated in a model epoxy composition enhanced fracture toughness without losing modulus of the system. The epoxy composition comprised a bi-functional epoxy and a curing agent of aromatic diamine.

Core-shell particles functionalized with amino and other functional groups are being employed in the embodiments of the resin composition and the FRP composition to simultaneously enhance G_{IC} and retain other properties of the composite material such as compressive properties.

### SUMMARY OF THE INVENTION

Embodiments of the invention relate to a resin composition comprising two or more different kinds of thermosetting resins, wherein at least one of the two or more different kinds of the thermosetting resins is a multifunctional resin, and a toughening agent comprising a first component and a second component, wherein a composition of the first component is different from a composition of the second component and the composition of the second component has a branched polymer structure comprising at least one main chain and at least one side chain, the main chain or the side chain containing at least one functional group that reacts with the thermosetting resin. Preferably, the thermosetting resin comprises two or more different kinds of thermosetting resins. Preferably, the thermosetting resin comprises a multifunctional resin. Preferably, the toughening agent comprises a core-shell structure having a core and a shell and the first component comprises the core and the second component comprises the shell. Preferably, the core-shell structure comprises a core-shell particle is in an amount of between 1 to 75 parts based on 100 parts per of the thermosetting resin. Preferably, the shell of the core-shell particle is softer than the core. Preferably, the core-shell particle size has a diameter in a range from about 0.01 micron to about 50 micron. Preferably, the branched polymer structure comprise a hyperbranched or dendritic polymer structure comprising at least one functional group comprising amino, hydroxyl, epoxide, carbonyl or their mixtures thereof, wherein the functional group is located in a main chain, a side chain or a terminating chain of the branched polymer structure. Preferably, the composition of the first component comprises a polymer, copolymer or block copolymer that is polymerized from a monomer, an inorganic compound, or a mixture of polymeric and inorganic materials. Preferably, the monomer comprises a vinylic monomer, an acrylate monomer, an acrylamide monomer, a polymerizable nitrile monomer, an acetate monomer, a fluoride monomer, a chloride monomer, a styrenic monomer, a diene monomer, or another monomer containing an unsaturated carbon-carbon. Preferably, the inorganic compound comprises clay, silicon carbide, polyhedral oligomeric silsesquioxane (POSS), silica, carbon black, carbon nanoparticle, a nanotube, a carbon nanotube, a carbon nanofiber, diamond, ceramic, a metal particulate, or a metal oxide. Preferably, the core is 0.5-75 wt % of total weight of the core-shell particle. Preferably, the shell is 0.1-500 nm thick and is 0.01 to 50 wt % of the total weight of the core-shell particle. Preferably, the core-shell particle in the thermosetting resin is prepared by mixing the resin with the particle in either a form of a dried powder or as particle dispersion in a solvent which is subsequently removed under heat and vacuum.

The resin composition could further comprise a toughening material comprising pigment, elastomer, copolymer, block copolymer, a carbon compound, graphite, carbon black, carbon nanotube, carbon nanoparticle, carbon nanofiber, an inorganic compound, clay, silicon carbide, POSS, glass, metal particulate or a metal oxide.

The resin composition could further comprise a thermoplastic particle having a particle size of no more than 100 μm, the thermoplastic particle being insoluble or partially soluble in the resin composition after the resin composition is cured. Preferably, the thermosetting resin comprises an additional thermoplastic polymer selected from a group consisting of polyvinyl formal, polyamide, polycarbonate, polyacetal, polyvinylacetal, polyphenyleneoxide, polyphenylenesulfide, polyarylate, polyester, polyamideimide, polyimide, polyetherimide, polyimide having phenyltrimethylindane structure, polysulfone, polyethersulfone, polyetherketone, polyetheretherketone, polyaramid, polyethernitrile, and polybenzimidazole; the thermoplastic polymer being soluble or partially soluble in the resin composition after the resin composition is cured. Preferably, the thermosetting resin is selected from the group consisting of epoxy resin, cyanate ester resin, saturated polyester, unsaturated polyester, urethane resin, polyimide resin, polyethermide, maleimide, bismaleimide-triazine, resorcinolic resin, diallylphthalate resin, amino resin, silicone resin, phenolic resin, furan resin, benzoxazine resin, allyl resin, and combinations thereof. Preferably, the epoxy resin comprises mono-, di-, or higher functional epoxies, or their mixtures thereof; the resin composition further comprising a curing agent and an accelerator, the curing agent comprising dicyandiamide, aromatic diamines, aminobenzoate, aliphatic amines, imidazole derivatives, tetramethylguanidine, carboxylic acid anhydrides, carboxylic acid hydrazides, phenol-novolac resins, cresol-novolac resins, carboxylic acid amides, polyphenol compounds, polymercaptans, or Lewis acid complexes; the accelerator comprises urea derivatives, imidazole derivatives or tertiary amines.

Another embodiment relates to a resin composition comprising a thermosetting resin and a core-shell particle having a core and a shell, wherein a composition of the core is different from a composition of the shell and the composition of the shell has a branched polymer structure comprising at least one main chain and at least one side chain, the main chain or the side chain containing at least one functional group that reacts with the thermosetting resin, wherein the resin composition has the following properties after curing the resin composition:

modulus≧3.0 GPa

K_{IC}≧0.8 MPa-m^{1/2}.

Another embodiment relates to a method of manufacturing a resin composition comprising obtaining two or more different kinds of thermosetting resins, wherein at least one of the two or more different kinds of the thermosetting resins is a multifunctional resin, and obtaining a core-shell particle having a core and a shell, wherein a composition of the core is different from a composition of the shell and the composition of the shell has a branched polymer structure comprising at least one main chain and at least one side chain, the main chain or the side chain containing at least one functional group that reacts with the thermosetting resin, and dispersing the core-shell particle in the two or more different kinds of the thermosetting resins by a solvent dispersion or a powder dispersion. Preferably, the core-shell particle in the thermosetting resin is prepared by mixing the resin with the particle in either a form of a dried powder or as a dispersion of the core-shell particle in a solvent which is subsequently removed under heat and vacuum, wherein the core-shell particle is present in the thermosetting resin at an amount between 1 to 75 parts per hundred parts of the thermosetting resin. Preferably, the dried powder is collected in a process in which core-shell particles in a reaction solvent are concentrated with counterions or polycounterions, followed by core-shell particle removal, drying and milling.

Another embodiment relates to a composite composition comprising a reinforcing fiber and a resin composition of the embodiments disclosed herein. The resin composition could further comprise a curing agent having two or more aromatic rings in a formula of the curing agent.

In another embodiment, the toughening agent could have a linear, non-spherical or irregular structure. Preferably, the linear structure comprises a needle shaped, cylindrical or fibrous structure.

Yet another embodiment relates to a resin composition comprising two or more different kinds of thermosetting resins, wherein at least one of the two or more different kinds of the thermosetting resins is a multifunctional resin, and a toughening agent comprising a first component and a second component, wherein a composition of the first component is different from a composition of the second component and the composition of the second component has a linear polymer structure containing at least one functional group comprising amino, epoxide, hydroxyl, carbonyl or their mixtures thereof.

### BRIEF DESCRIPTIONS OF THE DRAWINGS

FIG. 1 shows a schematic of a core-shell (dendrimer) structure. The core could be made from polystyrene, and shell could be made from polyethyleneimine. Core and shell materials are covalently bonded through C—N bonds.

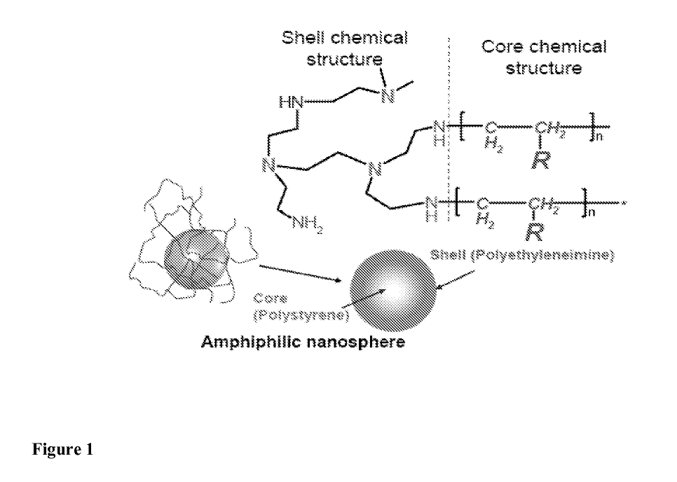

### DETAILED DESCRIPTION OF THE INVENTION

### Thermosetting Resin and Curing Agent/Optional Accelerator

The resin composition of the present invention includes a thermosetting resin. A thermosetting resin defined in the present invention is any resin which can be cured with a curing agent by means of an external energy such as heat, light, electromagnetic waves such as microwaves, UV, electron beam, or other suitable methods to form a three dimensional crosslink network. A curing agent is defined as any compound having at least an active group which reacts with the resin. A curing accelerator can be used to accelerate cross-linking reactions between the resin and curing agent.

The thermosetting resin is selected from, but not limited, epoxy resin, cyanate ester resin, maleimide resin, bismaleimide-triazine resin, phenolic resin, resorcinolic resin, unsaturated polyester resin, diallylphthalate resin, urea resin, melamine resin, benzoxazine resin, and their mixtures thereof.

Of the above thermosetting resins, epoxy resins are suitable for products of the present invention. Especially more preferred are di-functional epoxy resins or multifuctional epoxy resins having more than two epoxy functional groups. These epoxies are prepared from precursors such as amines (e.g., tetraglycidyldiaminodiphenylmethane, triglycidyl-p-aminophenol, triglycidyl-m-aminophenol and triglycidylaminocresol and their isomers), phenols (e.g., bisphenol A epoxy resins, bisphenol F epoxy resins, bisphenol S epoxy resins, phenol-novolack epoxy resins, cresol-novolac epoxy resins and resorcinol epoxy resins), and compounds having a carbon-carbon double bond (e.g., alicyclic epoxy resins). It should be noted that the epoxy resins are not restricted to the examples above. Halogenated epoxy resins prepared by halogenating these epoxy resins can also be used. Furthermore, mixtures of two or more of these epoxy resins, and monoepoxy compounds can be employed in the formulation of the thermosetting resin matrix.

Examples of suitable curing agents for epoxy resins include, but not limited to, polyamides, dicyandiamide, amidoamines, aromatic diamines (e.g., diaminodiphenylmethane, diaminodiphenylsulfone), aminobenzoates (e.g., trimethylene glycol di-p-aminobenzoate and neopentyl glycol di-p-amino-benzoate), aliphatic amines (e.g., triethylenetetramine, isophoronediamine), cycloaliphatic amines (e.g., isophoron diamine), imidazole derivatives, tetramethylguanidine, carboxylic acid anhydrides (e.g., methylhexahydrophthalic anhydride, carboxylic acid hydrazides (e.g., adipic acid hydrazide), phenol-novolac resins and cresol-novolac resins, carboxylic acid amides, polyphenol compounds, polysulfide and mercaptans, and Lewis acid and base (e.g., boron trifluoride ethylamine, tris-(diethylaminomethyl) phenol).

Depending on the desired properties of a cured product, a suitable curing agent is selected from the above list. For examples, if dicyandiamide is used, it will provide the product good elevated-temperature properties, good chemical resistance, and good combination of tensile and peel strength. Aromatic diamines, on the other hand, will give moderate heat and chemical resistance and high modulus. Aminobenzoates will provide excellent tensile elongation though they have inferior heat resistance compared to aromatic diamines. Acid anhydrides will provide the resin matrix low viscosity and excellent workability, and subsequently, high heat resistance after cured. Phenol-novolac resins or cresol-novolac resins provide moisture resistance due to the formation of ether bonds, which have excellent resistance to hydrolysis. Above all, a curing agent having two or more aromatic rings such as 4,4′-diaminodiphenyl sulfone will provide high heat resistance, chemical resistance and high modulus is more preferred curing agent for epoxy resins in this invention.

Examples of suitable accelerator/curing agent pairs for epoxy resins are borontrifluoride piperidine or p-t-butylcatechol for aromatic amine, urea or imidazole derivatives for dicyandiamide, and tertiary amines or imidazole derivatives for carboxylic anhydride or polyphenol compound. If an urea derivative is preferably used, urea derivatives may be compounds obtained by reacting with secondary amines with isocyanates. Such accelerators are selected from the group of 3-phenyl-1,1-dimethylurea, 3-(3,4-dichlorophenyl)-1,1-dimethylurea (DCMU) and 2,4-toluene bis-dimethyl urea. High heat resistance and water resistance of the cured material are achieved, though it is cured at a relatively low temperature.

### Toughening Agent Including Core-Shell Particles

The present resin composition contains a toughening agent having two components with different chemical compositions. The toughening agent is also referred to as core/shell material. The predominant core material is made from a material which has higher modulus than rubber to retain the resin modulus that would have been lost if such rubbery materials are used. Typical rubber modulus is 0.01-0.1 GPa. The core material is either a polymer, copolymer, or block copolymer which are polymerized from one or more types of monomers selected from, but not limited to, the groups consisting of vinylic monomers, acrylate monomers, acrylamide monomers, polymerizable nitrile, acetate, fluoride monomers, chloride monomers, styrenic monomers, and diene monomers, or an inorganic material such as clay, polyhedral oligomeric silsesquioxane (POSS), silica, carbon material (e.g., carbon black, carbon nanoparticle, carbon nanotube, carbon nanofiber), silicon carbide, ceramic and metal oxides. Moreover, the core can have one or multiple layers whose materials are selected from the above list. Of the above core materials, polymeric materials are preferred for the present invention to high toughness to the thermosetting resin.

The shell material, on the other hand, is preferably softer than the core material, or a rubbery material. It is more preferably for the shell material to contain functional groups chemically interacting with the thermosetting resin. Such functional groups can be, but not limited to, amino, epoxide, hydroxyl, and carbonyl group (e.g., carboxylic and acid anhydride group).

Combination of core and shell materials can be assembled into a core-shell structure either by grafting the shell material onto a preformed core material, or in a polymerization reaction between the core and shell materials. In the latter, the core material is covered by the shell material. Core-shell structure comprising core-shell particle having a spherical or non-spherical or irregular shape is preferred for the present invention. However, it should be noted that the structure or shape or form of the present toughening agent is not restricted to core-shell particle structure. Irregular structures or forms of the toughening agent are possible, which depends on combination and composition of starting materials, solvent, synthesis conditions, and post processing conditions. Examples of these forms include a linear (i.e., string or worm-like) structure, a needle-like, cylindrical or fibrous structure, ellipsoidal, discoidal, tabular, equant, or another structure which can be classified as non-spherical or irregular.

The toughening agent is preferably a core-shell particle. For such a material, it is expected that a large amount of mechanical energy is needed to destroy interactions between the shell and the resin. Therefore, toughening effects are predominantly coming from the shell. Crack energy is presumably dissipated by a series of mechanisms including interfacial stretching, interfacial debonding, matrix cavitation around the debonded area, which are ultimately followed by shear band formation, particle stretching/bridging, and particle breaking. The core-shell particles are hereby referred to as hard core-soft shell particles, whose relative hardness between the core and shell materials can be determined by preferably a pulsed-force-mode atomic force microscope (PFM-AFM) scanned over the particle or its cross-sectional area.

At least one functional group residing on the chemical chain which makes up the shell is preferred to revoke a number of desired toughening mechanisms. The chain architecture in the present invention can be linear, branched or hyperbranched dendritic. More preferred is branched structure with at least one main chain and at least on side chain. Most preferred is the hyperbranched dendritic structure, which can generally be described as three dimensional highly branched molecules having a treelike structure. Hyperbranched dendritic macromolecules normally consist of an initiator or nucleus having one or more reactive sites and a number of branching layers and optionally one or more spacing layers and/or a layer of chain terminating molecules. The layers are usually called generations and the branches dendrons. Polymers having a hyperbranched dendritic structure are hereby referred to dendrimer, dendroned polymer, hyperbranched polymer, brush-polymer, star or starbranched polymer, or similar macromolecules. Dendrimers are highly symmetric, while other macromolecules may, to a certain degree, hold an asymmetry, yet maintaining the highly branched treelike structure. Functional groups are typically found on the main chains and/or terminal (side) chains of these polymers. Typical functional groups include amino, epoxide, hydroxyl, carbonyl such as carboxyl and anhydride group, or a mixture thereof. Such polymers typically behave like rubbery materials when incorporated in the thermosetting resin, due to their internal structure, which often contains a non-reactive internal area acting like an empty space.

The effectiveness of the core-shell particles on toughening the resin is measured by the total amount of crack energy dissipated through one or more described mechanisms. Besides the material design, particle size, shell thickness, and particle composition are also important. Particle size in the present invention is desired to be less than 1 micron to penetrate the fiber bed, more preferably 10-650 nm, most preferably 50-300 nm. If desired to concentrate particles in the interlayer areas with or without materials different from the thermosetting resin, the effective aggregate size is preferably less than 100 micron, more preferably 10-50 micron. The overall shell thickness is preferred to be less than 1000 nm, more preferred 0.1-200 nm, most preferred is 0.1-100 nm. Shell composition determined by combustion analysis is preferred to be less than 50 wt % of the total particles. More preferably is between 0.1 to 15 wt %. Thicker shell with many functional groups distributed throughout the shell is preferred to maximize the energy dissipation capability. Yet, this might increase the resin viscosity, which for some cases are not desirable.

For epoxy resins and other suitable resins, as an example, a core material can be either a polymer polymerized from monomers such as vinylic monomers, acrylate monomers, acrylamide monomers, polymerizable nitrile, acetate, fluoride monomers, chloride monomers, styrenic monomers, and diene monomers, or an inorganic material selected in a group of compounds consisting of clay, polyhedral oligomeric silsesquioxane (POSS), silica, carbon material (e.g., carbon black, carbon nanoparticle, carbon nanotube, carbon nanofiber), silicon carbide, ceramic and metal oxides. Moreover, the core can have one or multiple layers whose materials are selected from the above list. Polymeric core materials are preferable for the present invention. More preferable are polymers having at least an aromatic ring in the polymer structure.

Shell material can be a compound contains one or more functional groups consisting of amino, epoxide, hydroxyl, and carbonyl group (e.g., carboxylic and acid anhydride group). Preferred is a nitrogen-containing polymer, which can be natural or synthetic, for epoxy and other suitable thermosetting resins. The nitrogen is preferably present as an amino group. Primary amine, secondary amine, and tertiary amine are the preferred functional groups for the strong interactions with the epoxy resin and other resins, which are compatible or reactive to amino groups. Structurally, the amino containing polymer is linear, branched, or hyperbranched dendritic. Preferred is the branched structure with at least one main chain and at least one side chain. The amino function may be located on the polymer's main chain or on the side chains. More preferred are amino polymers having a hyperbranched dendritic architecture structure such as polyalkylimine (e.g., polyethyleneimine or PEi, polypropyleneimine or PPi), and polyamidoamine (PAMAM). Combination of more preferred core and more preferred shell materials is preferably to form a core-shell particle structure. Such particles are hereby referred to as core-shell (dendrimer) particles or CSD particles.

Optionally, the shell material could have a linear structure with, especially, amino groups. In one embodiment, the toughening agent could comprise a reactive toughening material such as a copolymer or a core-shell particle having a shell component containing poly(diglycidyl methacrylate) or similar material having a linear structure. Other linear polymers with other functional groups may also be included in other embodiments.

In yet other embodiments, even though the toughening agent could be a core/shell material, it does not necessary mean that the toughening agent has a core-shell particle structure.

An embodiment of the present invention discloses a method to disperse core-shell material in a thermosetting resin such as epoxy after purified. Core-shell material synthesized in a solvent can be purified by a batch or continuous centrifuge, or a process in which counter-charged ions are used to aggregate particles which are removed from the solvent either by filtration or centrifugation. The counter-charged ion can be monovalence or higher (e.g., nitrate, sulfate), or polyvalence (e.g., pyrophosphate), or combinations thereof. The collected particles can be redispersed in a more volatile solvent which is removed under heat and vacuum when the dispersion is mixed with the epoxy. Other suitable solvent exchange techniques without using those counter-ions can be used. In this case, a suitable solvent is added to the particle dispersion, which allows particles to concentrate in the solvent phase and to be extracted along with the solvent from the original reaction solvent. Alternatively, aggregates after removed from the original reaction solvent by either above-mentioned method can be dried, and milled to fine powder. After mixed in an epoxy, the powder is further processed using a high shear technique such as 3-roll milling, homogenization, or microfluidization or a suitable method to achieve a master batch of dispersed particles and epoxy. A diluents or a solvent which can be removed afterward can be used to lower the epoxy viscosity for ease of processing. For both cases, the epoxy containing the core-shell material is incorporated in the present composite composition. The core-shell component preferably constitutes less than 75 parts per 100 parts (75 phr) of the resin. More preferred is between 1-20 phr.

### Thermoplastic Additives

Suitable thermoplastic additives can be added to the present composite composition. The thermoplastic additives are selected to modify viscosity of the thermosetting resin for processing purposes, and/or enhance its toughness. The thermoplastic additives, when present, may be employed in any amount up to 50 phr. More preferred is up to 20 phr for ease of processing.

It is preferable to use, but not limited to, the following thermoplastic materials such as polyvinyl formal, polyamide, polycarbonate, polyacetal, polyphenyleneoxide, poly phenylene sulfide, polyarylate, polyester, polyamideimide, polyimide, polyetherimide, polyimide having phenyltrimethylindane structure, polysulfone, polyethersulfone, polyetherketone, polyetheretherketone, polyaramid, polyethernitrile, polybenzimidazole, and their mixtures thereof.

More preferable are aromatic thermoplastic additives which do not impair high thermal resistance and high elastic modulus of the resin. Preferably, the selected thermoplastic additive is soluble in the resin to form a homogeneous mixture. Preferred thermoplastic additives for the present invention are compounds having aromatic skeleton from the following group consisting of polyimide, polyamide, polyethersulfone, polysulfone, and polyketone.

### Additional Particles Added to the Resin

Other polymeric or inorganic toughening agent can be used in addition to the present core-shell material to further enhance fracture toughness of the resin. Preferred particles are less than 5 micron in diameter, more preferred less than 1 micron. Such toughening agents include, but not limited to, block copolymer, core-shell rubber particles, oxides or inorganic materials with or without surface modification such as clay, polyhedral oligomeric silsesquioxane (POSS), carbon materials (e.g., carbon black, carbon nanotube, carbon nanofiber, fullerene), ceramic and silicon carbide. Examples of known block copolymers, which might form core-shell particles, include “Nanostrength®” SBM (polystyrene-polybutadiene-polymethacrylate), and AMA (polymethacrylate-polybutylacrylate-polymethacrylate), both produced by Arkema. “KaneAce MX” product line (produced by Kaneka Texas Corp.), which have polybutadiene, styrene or their combinations for core and a proprietary polymeric shell compatible with a thermosetting resin. “JSR SX” series of carboxylated polystyrene/polydivinylbenzene produced by JSR Corporation. “Kureha Paraloid” EXL-2655 (produced by Kureha Chemical Industry Co., Ltd.), which is a butadiene alkyl methacrylate styrene copolymer; “Stafiloid” AC-3355 and TR-2122 (both produced by Takeda Chemical Industries, Ltd.), each of which are acrylate methacrylate copolymers; “PARALOID” EXL-2611 and EXL-3387 (both produced by Rohm & Haas), each of which are butyl acrylate methyl methacrylate copolymers. Examples of known oxide particles include Nanopox® produced by nanoresins AG. This is a master batch of functionalized nanosilica particles and an epoxy.

### Interlayer Tougheners

Another embodiment of the present invention is to use the present toughening agent with other interlayer toughening materials to maximize damage tolerance and resistance of FRP composite materials. These materials are typically thermoplastic, elastomer, or combination of elastomer and thermoplastic, or of elastomer and inorganic such as glass. The size of these thermoplastic particles is preferably no more than 100 μm, more preferably 10-50 μm. Such organic particles are generally employed in amounts of no more than 30%, preferably no more than 15% by weight (based upon the weight of total resin content in FRP composition).

An example of the thermoplastic materials includes polyamides. Known polyamide particles include SP-500, produced by Toray Industries, Inc., “Orgasole” produced by Atochem, and Grilamid TR-55 produced by EMS-Grivory.

Another embodiment of the present invention is to use the present core-shell material for interlayer toughening purpose. If preferred, the present core-shell material can be aggregated to form large particles. Preferred aggregate size is from 5-100 micron. More preferably is between 10-50 micron. Synergistic toughening effect by populating core-shell material inside the fiber bed and in the interlayer area with different particle size is also preferred.

### Reinforcing Fibers

The reinforcing fibers used in the present invention can be, but not limited to, any of the following fibers and their combinations: carbon fibers, organic fibers such as aramide fibers, silicon carbide fibers, metal fibers (e.g., alumina fibers), boron fibers, tungsten carbide fibers, glass fibers, and natural/bio fibers. Among these fibers, carbon fibers, especially graphite fibers, are more preferable for use in the present invention. Carbon fibers with a strength of 2000 MPa or higher, an elongation of 0.5% or higher, and modulus of 200 GPa or higher are preferred. More preferred are fibers with tensile strength of greater than 3500 MPa, and elongation of greater than 1% and modulus of greater than 220 GPa.

The morphology and location of the reinforcing fibers used in the present invention are not specifically defined. Any of morphologies and spatial arrangements of fibers such as long fibers in a direction, chopped fibers in random orientation, single tow, narrow tow, woven fabrics, mats, knitted fabrics, and braids can be employed. For applications where especially high specific strength and specific modulus are required, a composite structure where reinforcing fibers are arranged in a single direction is most suitable, but cloth (fabric) structures, which are easily handled, are also suitable for use in the present invention.

### Fabrication Techniques for Manufacturing the FRP Composites

To combine fibers and resin matrix to produce a prepreg or a ply in the present invention, employable is a wet method in which fibers are soaked in a bath of the resin matrix dissolved in a solvent such as methyl ethyl ketone or methanol, and withdrawn from the bath to remove solvent.

Another method is hot melt method, where the epoxy resin composition is heated to lower its viscosity, directly applied to the reinforcing fibers to obtain a resin-impregnated prepreg; or alternatively, the epoxy resin composition is coated on a release paper to obtain a thin film. The film is consolidated onto both surfaces of a sheet of reinforcing fibers by heat and pressure.

To produce a composite article from the prepreg, for example, one or more plies are applied onto to a tool surface or mandrel. This process is often referred to as tape-wrapping. Heat and pressure are needed to laminate the plies. The tool is collapsible or removed after cured. Curing methods such as autoclave and vacuum bag are typically preferred. However, other suitable methods can also be employed. In autoclave method pressure is provided to compact the plies, while vacuum-bag method relies on the vacuum pressure introduced to the bag when the part is cured in an oven. Autoclave method is preferred for high quality composite parts.

Without forming prepregs, the epoxy resin composition of the present invention may be directly applied to reinforcing fibers which were conformed onto a tool or mandrel for a desired part's shape, and cured under heat. Preferred methods include, but not limited to, filament-winding, pultrusion molding, resin injection molding and resin transfer molding/resin infusion.

### Examples

Next, the present invention is described in detail by means of the following examples with the following components:
Epoxy resin A is a tetra glycidyl diamino diphenyl methane with a functionality of 4, having an average EEW of 120 (e.g., ELM434, made by Sumitomo Chemical Co., Ltd.).
Epoxy resin B is a diglycidyl ether of bisphenol A with a functionality of 2, having an average EEW of 177 (e.g., Epon™ 825, made by Hexion Specialty Chemicals, Inc.)
Epoxy resin C is a diglycidyl ether of bisphenol F with a functionality of 2, having an average EEW of 177 (e.g., Epiclon 830 or EPc 830, made by Dainippon Ink and Chemicals, Inc.)
Thermoplastic A is polyethersulfone (e.g., Sumikaexcel PES5003P, made by Sumitomo Chemical Co., Ltd.)
Thermoplastic B is polyamide (e.g., Gilamid TR55, made by Emzaberk Co.)
Curing agent A is diethyltoluenediamine, (Epikure W or EPW, made by Hexion Specialty Chemicals, Inc.)
Curing agent B is 4,4′-diaminodiphenyl sulfone or DDS (ARADUR 9664-1, made by Huntsman Advanced Materials)
Toughening agent A are core-shell(dendrimer) (CSD) particles
Toughening agent B is core-shell rubber (CSR) particles (Kane Ace MX416, made by Kaneka Texas Corporation)
Carbon fibers A are Torayca T800S-24K-10E produced by Toray Industries, Inc. (24,000 fibers, tensile strength 5.9 GPa, tensile modulus 290 GPa, tensile strain 2.0%)

CSD particles were made in isopropyl alcohol (IPA) as follows. Dried, 12.5-branched polyethyleneimine (PEi) of molecular weight of 750,000, t-butyl hydroperoxide (TBHP) 70 wt % in H₂O and styrene monomers were purchased from Sigma Aldrich (St. Louis, Mo.). 50 gm of PEi gel was dissolved in 1 liter of isopropyl alcohol (IPA) in a 2 liter beaker. Styrene monomer was added to the beaker to achieve the core to shell material ratio of 5. The well-stirred mixture was transferred to a 4 liter reactor vessel equipped with water-jacket, thermometer, overhead stirring system, and nitrogen gas flow. The reactor volume was filled up with an additional amount of IPA. After the reactants were stirred at 320 rpm and purged with nitrogen for 45 min, 4 mL of TBHP were added dropwise, and the temperature was increased to 83° C. The reaction was allowed to stop after 2.5 hours.

The dispersion was centrifuged at 10,000 rpm in a refrigerated centrifuge for 60 min. Temperature was kept at 10° C. for the whole processing duration. After centrifuged, the solid was collected and re-dispersed in IPA by a mean of mechanical stirring until all the solid was suspended in IPA. The centrifuge procedure was repeated to obtain second re-dispersion with final particle concentration of 20 wt %. The collected particles might also have been dried and mixed in the epoxy resin as the powder; however, it was not explored.

CSD particles with the same ratio of starting materials were made in water following the same procedure as above. The reaction, however, was run at 85° C. for 2.5 hr. Conversion determined by the solid content was greater than 90%. There particles were concentrated by 250 mM sulfuric acid, and collected by either vacuum filtration or centrifugation. The aggregates were washed with water and methanol or suitable solvents with the wash ratios of 50 mL per gram of solid and 20 mL per gram, respectively. The washed aggregates were either redispersed in methanol by a mean of high shear or dried in an oven overnight at 50° C. and ground to fine powder.

Combustion analysis of a powder sample of particles was used to determine the particle composition. For particles made in IPA after purified by a centrifuge, the ratio of N to C was 1.4%, which is approximately translated to 4.1 wt % of the shell material. That of the unpurified was 2.9% or 8.2 wt % PEi. For particles made in water, the values were 5.5% (15.2 wt % PEi) and 3.5% (10 wt % PEi) for the unpurified and purified, respectively. Notice that the amount of PEi in the unpurified might include the unreacted PEi.

A transmission electron microscope (TEM) was used to determine particle structure, while a scanning electron microscope (SEM) was for particle size, particle's surface structure and particle dispersion and micro-failure modes of particle on the fracture surface of cured epoxy. The particle size could be the diameter of a circumscribed circle around an individually distinguished particle. A high magnification optical microscope besides SEM can also be used to detect the particle and determine the size. In addition, to determine particle size distribution when they are in a solvent, a light scattering technique could be used. For particles made in IPA, a wide range of particle size distribution of 50-650 nm was observed. The particle size distribution of particles made in water was 60-80 nm.

### Comparative Example 1 and Example 2

Comparative Example 1 and Example 2, where Comparative Example 1 is the control, demonstrate CSD particle performance with respect to particle loading in a resin matrix comprising of a multifunctional epoxy A, two bi-functional epoxy resins B, C, and a solid curing agent A containing two aromatic rings.

250 gm of epoxy mixture was mixed at 80° C. in a jacketed vessel equipped with a vacuum port and an overhead stirrer. Appropriate volume of CSD particle dispersion in isopropyl alcohol (IPA) or in methanol (MeOH) was slowly added to the epoxy mixture under vacuum to achieve the specified particle loadings of 10 parts per 100 parts of epoxy (10 phr). IPA vapor was condensed and collected in a flask cooled by liquid nitrogen. The mixture was kept under vacuum for an additional 2 hr after no bubbles were observed and no more IPA was collected. After vacuum was removed, the curing agent A was added to the vessel and mixed for 30 min at 60° C. The mixture was discharged to a container.

The hot mixture was degassed in a planetary mixer rotating at 15000 rpm for a total of 20 min, and poured into a metal mold with 0.25 in thick Teflon insert. The resin matrix was heated to 182° C. with the ramp rate of 1.7° C./min, allowed to dwell for 3 hr to complete curing, and finally cooled down to room temperature. Resin plates were prepared for testing according to ASTM D-790 for flexural test, and ASTM D-5045 for fracture toughness test. The cured resin T_{g} was determined by dynamic mechanic analysis (DMA) on an Alpha Technologies Model APA 2000 instrument.

### Comparative Example 3 and Example 4

In Comparative Example 3 and Example 4, where Comparative Example 3 is the control, additional thermoplastic component was added to the composition of Comparative Example 1 and Example 2 to further increase fracture toughness. Prepregs comprising these resin matrices and carbon fibers A were also made.

The thermoplastic additive A in the powder form was charged with the epoxy mixture in the vessel preheated at 80° C. The mixture was stirred and heated to 160° C. and kept it there for 1 hr to make sure all the thermoplastic A dissolved in the epoxies. After the mixture was cooled to 80° C., CSD particle dispersion was added in a similar fashion as in Example 2. The temperature was raised to 100° C. for 2 hr, after all CSD particle dispersion was charged, to completely remove IPA. Hardener A was added to the vessel after the mixture was cooled down to 60° C. and mixed for 1 hr.

Resin plates were made and tested following the procedure in Comparative Example 1 and Example 2.

To make a prepreg, each of resin matrices was first casted into a thin film using a knife coater onto a release paper. The film was consolidated onto a bed of fibers on both sides by heat and compaction pressure. A UD prepreg having carbon fiber area weight of 190 g/m² and resin content of 35% was obtained. The prepregs were cut and hand laid up with the sequence listed in Table 2 for each type of mechanical test, followed an ASTM procedure. Panels were cured in an autoclave at 180° C. for 2 hr with a ramp rate of 1.7° C./min and a pressure of 0.59 MPa.

### Example 5

The composition was similar as in Example 4. However, in this example CSD powder was used instead of CSD dispersion.

The above mixing sequence was slightly changed to accommodate the CSD powder. After the mixture of thermoplastic A and epoxies was cooled from 160 to 100° C., 15 phr CSD powder was introduced and mixed for 2 hr. The hardener A was added to the particles modified epoxy resin matrix when it was cooled down to 60° C. Mixing was allowed for 1 hr.

Resin plates and laminates were prepared and tested as in Examples 4-5.

### Example 6

This example explores the combination of interlayer and intralayer toughening approaches.

After CSD powder was introduced and mixed in the mixture of epoxies and thermoplastic A as in Example 5, the temperature was dropped to 70° C. Thermoplastic B, after being ground into powder, was added and mixed for 30 min. The volume-average particle size determined by a centrifugal sedimentation rate method was 20 micron. Hardener A was added to the mixture and mixed for 1 hr. This resin was used to make the second layer of the prepreg, while resin from Example 5 was used for the first layer as described below.

Resin compositions of Example 5 and present Example 6 were cast into thin films onto a release paper using a knife coater. The film from Example 5 was first consolidated onto a fiber bed on both sides by heat and pressure, followed by consolidation of the film from present Example 6. A UD prepreg having carbon fiber area weight of 190 g/m² and resin content of 35% was obtained. The CFRP panels were prepared for testing as in Examples 4-5.

### Comparative Examples 7-9

In these examples, where Comparative Example 7 is the control, two bi-functional epoxies B and C were used along with a liquid curing agent B. This will allow a direct comparison of these systems to less ductile (i.e., high modulus) systems presented in Comparative Example 1 and Example 2. In general, toughening is more effective with more ductile resin systems and for most aerospace applications high modulus and high fracture toughness are required.

Following the same procedure presented in Comparative Example 1 and Example 2, 10 phr and 20 phr of particle dispersion were incorporated in the epoxy resins in Comparative Examples 8 and 9, respectively. Hardener B was added to the mixture after all IPA was removed. The resins were mixed and degassed for 30 min and poured into the mold. The resins were heated to 120° C. with the ramp rate of 3° C./min and dwelled for 2 hr, followed by an additional dwell of 3 hr at 182° C., and finally cooled to room temperature. Resin plates were prepared for testing as in Comparative Example 1 and Example 2.

### Comparative Examples 10-11

In these examples, where Comparative Example 10 is the control, use only one bi-functional epoxy instead of two in Comparative Examples 7-9. In addition, CSD powder is used instead of CSD dispersion. This validates the performance of two particle systems in which one was made in IPA while the other in water. It also confirms the effectiveness of purification/dispersion technique associated with each system.

The fine CSD powder and epoxy B was stirred at 350 rpm in the vessel at 60° C. for 1 hr, followed by 1 hr at 100° C. Hardener B was added and degassed for 30 min. The resin was poured into the mold and cured in the same manner as Comparative Examples 7-9. Resin plates were prepared for testing as in Comparative Example 1 and Example 2.

### Comparative Example 12

This example is used to compare the performance of CSD particles against conventional core-shell (rubber) or CSR particles in resin. Base resin formulation was similar as in Comparative Example 1 and Example 2. CSR particles were provided in a master batch of 25 wt % particles in epoxy A.

An appropriate amount of CSR master batch was added to the epoxies A, B and C. The mixture was mixed at 100° C. for 1 hr, then cooled down to 60° C. at which hardener A was introduced and mixed for 1 hr. The resin plate was prepared as in Comparative Example 1 and Example 2 for mechanical testing.

### Comparative Example 13

This example is used to compare the performance of CSD particles against conventional core-shell (rubber) or CSR particles in composite. Base resin formulation was similar as in Comparative Example 3 and Examples 4-5. CSR particles were provided in a master batch of 25 wt % particles in epoxy A.

An appropriate amount of CSR master batch was added to the mixture of epoxies A, B and C and dissolved thermoplastic A at 100° C. and mixed for 1 hr. Hardener A was introduced at 60° C. and mixed for 1 hr. The resin plate and laminate was prepared as in Comparative Example 3 and Examples 4-5 for mechanical testing.

As shown in Table 1, CSD particles in general increase K_{IC} of the corresponding control systems (Comparative Examples 1, 7, 10) while retained their flexural modulus, or increased slightly. The enhancement of 50% or higher in K_{IC} was found comparable between two base resin systems with different ductility levels. Conventionally, it is more difficult to toughen a less ductile system with polymeric tougheners without first lowering its modulus. This was clearly shown in Example 2 and Comparative Example 12. Yet, the present resin compositions are more desired in that both high modulus and fracture toughness of the resulting resins were achieved. In addition, the methods of making particles in water and of purifying these particles were shown to have similar performances compared to those made in IPA and purified using simply a centrifuge.

For composite, G_{IC} of the particle modified resin matrix was found to increase 66% and 100% for particles made in IPA and water, respectively. Notice that the latter contained 15 phr CSD particles as opposed to 10 phr in the former. In addition, compared to CSR particles, CSD particles retained other compressive properties such as CAI, ultimate strength, OHC room temperature and OHC hot-wet. Other properties such as Tg and tensile were also retained.

Example 6 showed that by using both CSD particles and interlayer tougheners both G_{IC} and G_{IIC} increased significantly while other properties were retained.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. The numerical ranges disclosed inherently support any range within the disclosed numerical ranges though a precise range limitation is not stated verbatim in the specification because this invention can be practiced throughout the disclosed numerical ranges. Finally, the entire disclosure of the patents and publications referred in this application are hereby incorporated herein by reference.

TABLE 1

| | | | | Example (E) and Comparative Example (CE) | | | | | | | | | | | | |
|---|---|---|---|---|---|---|---|---|---|---|---|---|---|---|---|---|
| | | | | CE | | CE | | | | CE | CE | CE | CE | CE | CE | CE |
| | | | | 1 | E 2 | 3 | E 4 | E 5 | E 6 | 7 | 8 | 9 | 10 | 11 | 12 | 13 |
| Resin | Compo- | A | Epoxy A (EEW 120)/ | 20 | 20 | 20 | 20 | 20 | 20 | 0 | 0 | 0 | 0 | 0 | 20 | 20 |
| matrix | nent | | ELM434 | | | | | | | | | | | | | |
| compo- | | | Epoxy B (EEW 177)/ | 60 | 60 | 60 | 60 | 60 | 60 | 75 | 75 | 75 | 100 | 100 | 60 | 60 |
| sition | | | EPON825 | | | | | | | | | | | | | |
| (phr) | | | Epoxy C (EEW 177)/ | 20 | 20 | 20 | 20 | 20 | 20 | 25 | 25 | 25 | 0 | 0 | 20 | 20 |
| | | | EPc830 | | | | | | | | | | | | | |
| | | B | Curing agent A (AEW | 38.4 | 38.4 | 38.4 | 38.4 | 38.4 | 38.4 | 0 | 0 | 0 | 0 | 0 | 38.4 | 38.4 |
| | | | 62)/DDS | | | | | | | | | | | | | |
| | | | Curing agent B (AEW | 0 | 0 | 0 | 0 | 0 | 0 | 25 | 25 | 25 | 25 | 25 | 0 | 0 |
| | | | 44)/EPW | | | | | | | | | | | | | |
| | | C | Toughening agent A/CSD | 0 | 10 | 0 | 10 | 15 | 15 | 0 | 10 | 20 | 0 | 10 | 0 | 0 |
| | | | Toughening agent B/CSR | 0 | 0 | 0 | 0 | 0 | 0 | 0 | 0 | 0 | 0 | 0 | 10 | 10 |

| | | | | | | | | | | | | | | | |
|---|---|---|---|---|---|---|---|---|---|---|---|---|---|---|---|
| | Optional | Thermoplastic additive | 0 | 0 | 10 | 10 | 10 | 20 | 0 | 0 | 0 | 0 | 0 | 0 | 10 |
| | additive | A/PES | | | | | | | | | | | | | |
| | | Thermoplastic additive B | 0 | 0 | 0 | 0 | 0 | 40 | 0 | 0 | 0 | 0 | 0 | 0 | 0 |
| Cured | Flexure | Modulus, GPa | 3.1 | 3.2 | 3.2 | 3.2 | 3.3 | | 2.6 | 2.7 | 2.9 | 2.5 | 2.6 | 2.8 | 2.8 |
| resin | Fracture | K_{IC}, MPa-m^{1/2} | 0.6 | 0.9 | 0.6 | 1.0 | 1.2 | | 0.8 | 1.0 | 1.6 | 0.6 | 0.9 | 0.9 | 1.0 |
| Prop- | Toughness | | | | | | | | | | | | | | |
| erties | Heat | Tg (° C., cured resin | 210 | 202 | 208 | 196 | 205 | | | | | | | 207 | 204 |
| | Resistance | matrix) | | | | | | | | | | | | | |
| FRP | Compression | Ultimate strength (ksi) | | | 193 | 198 | 200 | 197 | | | | | | | 176 |
| Prop- | Damage | Open-hole compression | | | 41.3 | 40.6 | 41.5 | 43.0 | | | | | | | 36.4 |
| erties | Tolerance | RTD (ksi) | | | | | | | | | | | | | |
| | | Open-hole compression | | | 34.4 | 33.0 | 33.5 | | | | | | | | 28.4 |
| | | HW (ksi) | | | | | | | | | | | | | |
| | | Compression after | | | 23.9 | 25.5 | 26.0 | 40.1 | | | | | | | 23.3 |
| | | impact (ksi) | | | | | | | | | | | | | |
| | Tension | Ultimate strength (ksi) | | | 404 | 399 | 385 | 420 | | | | | | | 439 |
| | | Modulus (ksi) | | | 21.7 | 21.9 | 22.1 | 22.0 | | | | | | | 21.5 |
| | Fracture | G_{IC} (lb · in/in²) | | | 2.1 | 3.5 | 4.2 | 4.0 | | | | | | | 5.7 |
| | toughness | G_{II} (lb · in/in²) | | | 5.3 | 5.2 | 5.4 | 10.1 | | | | | | | 4.5 |

TABLE 2

| | | Panel Size | Ply Lay-up | Test |
|---|---|---|---|---|
| Test Panel | Test method | (mm × mm) | Configuration | Condition |
| Tensile | ASTM D 3039 | 300 × 300 | (0)₆ | RT |
| Compression | ASTM D | 300 × 300 | (0)₆ | RT |
| strength | 695/ASTM D | | | |
| | 3410 | | | |
| OHC (RTD) | ASTM D 6484 | 350 × 350 | (45/0/−45/90)_{S} | RT |
| OHC (HW) | ASTM D 6484 | 350 × 350 | (45/0/−45/90)_{S} | Hot |
| CAI | SACMA SRM | 350 × 350 | (45/0/−45/90)_{3S} | RT |
| | 2R-94/ASTM | | | |
| | D7137&BSS | | | |
| | 7260 | | | |
| DCB | ASTM D 5528 | 350 × 300 | (0)₂₀ | RT |
| (for G_{IC}) | | | | |
| ENF (for | JIS K 7086* | 350 × 300 | (0)₂₀ | RT |
| G_{IIC}) | | | | |

*Japanese Industrial Standard Test Procedure

What is claimed is:

1. A resin composition comprising two or more different kinds of thermosetting resins, wherein at least one of the two or more different kinds of the thermosetting resins is a multifunctional resin, and a toughening agent comprising a first component and a second component, wherein the toughening agent comprises a core-shell particles having a core and a shell, the core-shell particle size having a diameter in a range from about 0.01 micron to about 50 micron, the first component comprises the core and the second component comprises the shell, and, wherein a composition of the first component is different from a composition of the second component and the composition of the second component has a branched polymer structure comprising at least one main chain and at least one side chain, the main chain or the side chain containing at least one functional group that reacts with the thermosetting resin.

2. A resin composition comprising two or more different kinds of thermosetting resins, wherein at least one of the two or more different kinds of the thermosetting resins is a multifunctional resin, and a toughening agent comprising a first component and a second component, wherein a composition of the first component is different from a composition of the second component and the composition of the second component has a branched polymer structure comprising at least one main chain and at least one side chain, the main chain or the side chain containing at least one functional group that reacts with the thermosetting resin, and, wherein the toughening agent comprises a linear, non-spherical or irregular structure.

3. The resin composition of claim 2, wherein the linear structure comprises a needle shaped, cylindrical or fibrous structure.

4. The resin composition of claim 1, wherein the toughening agent comprises a core-shell structure having a core and a shell and the first component comprises the core and the second component comprises the shell.

5. The resin composition of claim 4, wherein the core-shell structure comprises a core-shell particle is in an amount of between 1 to 75 parts based on 100 parts per of the thermosetting resin.

6. The resin composition of claim 1, further comprising a thermoplastic toughening agent.

7. The resin composition of claim 4, wherein the shell is softer than the core.

8. The resin composition of claim 1, wherein the core-shell particle size has a diameter in a range from about 0.01 micron to about 1 micron.

9. The resin composition of claim 1, wherein the branched polymer structure comprise a hyperbranched or dendritic polymer structure comprising at least one functional group comprising amino, hydroxyl, epoxide, carbonyl or their mixtures thereof, wherein the functional group is located in a main chain, a side chain or a terminating chain of the branched polymer structure.

10. The resin composition of claim 1, wherein the composition of the first component comprises a polymer, copolymer or block copolymer that is polymerized from a monomer, a mixture of monomers, an inorganic compound, or a mixture of polymeric and inorganic materials.

11. The resin composition of claim 10, wherein the monomer comprises a vinylic monomer, an acrylate monomer, an acrylamide monomer, a polymerizable nitrile monomer, an acetate monomer, a fluoride monomer, a chloride monomer, a styrenic monomer, a diene monomer, or another monomer containing an unsaturated carbon-carbon.

12. The resin composition of claim 10, wherein the inorganic compound comprises clay, silicon carbide, polyhedral oligomeric silsesquioxane (POSS), silica, carbon black, carbon nanoparticle, a nanotube, a carbon nanotube, a carbon nanofiber, diamond, ceramic, a metal particulate, or a metal oxide.

13. The resin composition of claim 1, wherein the core-shell particle size has a diameter in a range from about 0.01 micron to about 0.65 micron.

14. The resin composition of claim 5, wherein the shell is 0.1-500 nm thick and is 0.01 to 50 wt % of the total weight of the core-shell particle.

15. The resin composition of claim 5, wherein the core-shell particle in the thermosetting resin is prepared by mixing the said resin with the said particle in either a form of a dried powder or as a dispersion of the core-shell particle in a solvent which is subsequently removed under heat and vacuum.

16. The resin composition of claim 1, further comprising a toughening material comprising pigment, elastomer, copolymer, block copolymer, a carbon compound, graphite, carbon black, carbon nanotube, carbon nanoparticle, carbon nanofiber, an inorganic compound, clay, silicon carbide, POSS, glass, metal particulate or a metal oxide.

17. The resin composition of claim 1, further comprising a thermoplastic particle having a particle size of no more than 100 μm, the thermoplastic particle being insoluble or partially soluble in the resin composition after the resin composition is cured.

18. The resin composition of claim 1, wherein the thermosetting resin comprises a thermoplastic polymer selected from a group consisting of polyvinyl formal, polyamide, polycarbonate, polyacetal, polyvinylacetal, polyphenyleneoxide, polyphenylenesulfide, polyarylate, polyester, polyamideimide, polyimide, polyetherimide, polyimide having phenyltrimethylindane structure, polysulfone, polyethersulfone, polyetherketone, polyetheretherketone, polyaramid, polyethernitrile, and polybenzimidazole; the thermoplastic polymer being soluble or partially soluble in the resin composition after the resin composition is cured.

19. The resin composition of claim 1, wherein the thermosetting resin is selected from the group consisting of epoxy resin, cyanate ester, saturated polyester, unsaturated polyester, urethane resin, polyimide resin, polyethermide, maleimide, bismaleimide-triazine, resorcinolic resin, diallylphthalate resin, amino resin, silicone resin, phenolic resin, furan resin, benzoxazine resin, allyl resin, and combinations thereof.

20. The resin composition of claim 19, wherein the epoxy resin comprises mono-, di-, or higher functional epoxies, or their mixtures thereof the resin composition further comprising a curing agent and an accelerator, the curing agent comprising dicyandiamide, aromatic diamines, aminobenzoate, aliphatic amines, imidazole derivatives, tetramethylguanidine, carboxylic acid anhydrides, carboxylic acid hydrazides, phenol-novolac resins, cresol-novolac resins, carboxylic acid amides, polyphenol compounds, polymercaptans, or Lewis acid complexes; the accelerator comprises urea derivatives, imidazole derivatives or tertiary amines.

21. A resin composition comprising a thermosetting resin and a core-shell particle having a core and a shell, wherein a composition of the core is different from a composition of the shell and the composition of the shell has a branched polymer structure comprising at least one main chain and at least one side chain, the main chain or the side chain containing at least one functional group that reacts with the thermosetting resin, wherein the resin composition has the following properties after curing the resin composition:
modulus≧3.0 GPa
K_{IC}≧0.8 MPa-m^{1/2}.

22. A method of manufacturing a resin composition comprising obtaining two or more different kinds of thermosetting resins, wherein at least one of the two or more different kinds of the thermosetting resins is a multifunctional resin, and obtaining a core-shell particle having a core and a shell, wherein a composition of the core is different from a composition of the shell and the composition of the shell has a branched polymer structure comprising at least one main chain and at least one side chain, the main chain or the side chain containing at least one functional group that reacts with the thermosetting resin, and dispersing the core-shell particle in the two or more different kinds of the thermosetting resins by a solvent dispersion or a powder dispersion.

23. The method of claim 22, wherein the core-shell particle is in the thermosetting resin in either a form of a dried powder or as a dispersion of the core-shell particle in a solvent, wherein the core-shell particle is present in the thermosetting resin at an amount between 1 to 75 parts per hundred parts of the thermosetting resin.

24. The method of claim 23, wherein the dried powder is collected in a process in which core-shell particles in a reaction solvent are concentrated with counterions or polycounterions, followed by core-shell particle removal, drying and milling.

25. A prepreg comprising a reinforcing fiber and a resin composition of claim 1.

26. A prepreg comprising a reinforcing fiber and a resin composition of claim 21.

27. The resin composition of claim 21, further comprising a curing agent having two or more aromatic rings in a formula of the curing agent.

28. A resin composition comprising two or more different kinds of thermosetting resins, wherein at least one of the two or more different kinds of the thermosetting resins is a multifunctional resin, and a toughening agent comprising a first component and a second component, wherein a composition of the first component is different from a composition of the second component and the composition of the second component has a linear polymer structure containing at least one functional group comprising amino, epoxide, hydroxyl, carbonyl or their mixtures thereof.
